(19) United States
(12) Patent Application Publication
(10) Pub. No.: US 2007/0134805 A1
(43) Pub. Date: Jun. 14, 2007

(54) Molecular detector arrangement

(75) Inventor: Richard Gilbert, Chelmsford (GB)

Correspondence Address: VENABLE LLP, P.O. BOX 34385, WASHINGTON, DC, 20043-9998, US

(73) Assignee: E2V Biosensors Limited, Chelmsford (GB)

(21) Appl. No.: 11/581,070

(22) Filed: Oct. 16, 2006

(30) Foreign Application Priority Data
Oct. 14, 2005 (GB) 0520944.0

(51) Int. Cl. G01N 21/00

(52) U.S. Cl. 436/164

(57) ABSTRACT

A method of detecting the presence or absence of an analyte in a sample uses an analyte carrier with a calibration dye held in a region near a metal surface. A reporter dye is held away from a region near the metal surface and is displaceably attached to a selective agent. The selective agent is capable of binding to an analyte so that when the analyte binds to the selective agent the reporter dye detaches and moves to a region near a metal surface. The difference in response to illumination from the reporter dye and calibration dye can be used to detect the presence, amount or absence of an analyte sample.

### CROSS-REFERENCE TO RELATED APPLICATION

This application claims the priority of GB 0520944.0, filed Oct. 14, 2005, the disclosure of which is incorporated herein by reference.

### FIELD OF THE INVENTION

The present invention relates to a molecular detector, a carrier for use in the molecular detector and a molecular detector assembly of carrier and detector. The invention particularly relates to detectors which use light scattering, such as Raman scattering or to detectors using fluorescence on light absorption.

### BACKGROUND OF THE INVENTION

It is known that there are many techniques to detect the action or presence of analyte molecules. One such technique utilizes the Raman Scattering (RS) effect. Light incident on a molecule is scattered and, as a result of a transfer of energy, a shift in frequency, and thus wavelength, occurs in the scattered light. The process leading to this inelastic scatter is termed the Raman effect. The shift in frequency is unique to the analyte molecule. The RS effect, however, is very weak, so a technique preferably using colloids is known to be used to enhance the effect. Analyte molecules placed within a few Angstroms of a metal surface, such as silver, gold, copper or other such materials, experience a transfer of energy from the metal surface through various mechanisms. This is known as Surface Enhanced Raman Scattering (SERS) and can be measured using conventional spectroscopic detectors.

Surface enhanced Raman spectroscopy (SERS) and its' extension, surface enhanced resonance Raman spectroscopy (SERRS) are gaining in popularity as quantitative bioanalytical tools. Both techniques rely to a large degree on an interaction between the ‘plasma’ of mobile conduction electrons at the surface of a metal (the plasmons) and molecular species close to that surface. This interaction results in a substantial enhancement of Raman scattering at specific vibrational energies, yielding a strong spectral signal in the Raman scattered light.

Until recently, a controversy surrounded the understanding of the enhancement mechanisms. The two major factions disagreed on the partitioning of the greater than 10⁶ enhancement factor between the chemical enhancement mechanism and the electromagnetic enhancement mechanism. The chemical enhancement mechanism, now thought to contribute an enhancement factor of 10², asserts that a charge-transfer state is created between the metal and adsorbate molecules. This mechanism is site-specific and analyte dependent. The molecule must be directly adsorbed to the surface in order to experience the chemical enhancement. The electromagnetic enhancement mechanism contributes a greater than 10⁴ times enhancement over normal Raman scattering. In order to understand the electromagnetic enhancement, one must consider the size, shape, and material of the surface's nanoscale roughness features. If the correct wavelength of light strikes a metallic roughness feature, the plasma of conduction electrons will oscillate collectively. Because this collective oscillation is localized at the surface of this plasma of electrons, it is known as a localized surface plasmon resonance (LSPR). The LSPR allows the resonant wavelength to be absorbed and scattered, creating large electromagnetic fields around the roughness feature. If a molecule is placed within the electromagnetic fields, an enhanced Raman signal is measured.

The strength and local density of the field is determined by a variety of parameters. The wavelength of the reflected light determines its energy, and the composition and morphology of the metal determines the strength and efficiency with which the surface plasmons couple to the photon energy. Other factors, such as the relative dielectric properties of the metal and analyte solution, also have strong contributions to the effect. In addition, the efficiency of energy transfer between the field and any molecules close to the metal surface is also determined by resonant energetic states in the molecule itself, including, for example, specific vibrational modes in the infrared spectral region and electronic energy transitions in the ultraviolet. This is the mechanism by which SERRS gains performance over conventional SERS.

We have appreciated the problem that the Raman scattering effect, even using surface enhanced Raman scattering (SERS), provides a small amount of Raman scattered radiation in comparison to normal scattering (effectively a poor signal to noise ratio). We have further appreciated that, because the Raman signal is weak in comparison to noise, there is a need to introduce a mechanism to help distinguish the Raman signal from noise.

### SUMMARY OF THE INVENTION

The invention is defined in the claims to which reference is directed. An embodiment of the invention uses surface enhanced Raman scattering (SERS) to detect the presence of an analyte in a region near a surface. Unlike known arrangements, the embodiment uses a reporter dye and a calibration dye in connection with a selective agent such as an antibody, so arranged that: the calibration dye is located in a region near a surface and the reporter dye is held away from a surface by the selective agent until an analyte molecule binds to the selective agent at which point the reporter dye is displaced and also becomes located in a region near a surface. This arrangement effectively provides calibration of the Raman signal scattered from the analyte molecule. In the absence of an analyte molecule, the Raman scattering due to surface enhanced Raman effect is predominantly from the calibration dye only. On binding of the analyte molecule, the reporter dye is displaced to a region near a surface such that it too provides a contribution to the surface enhanced Raman signal. This allows the ratio of signals from the reporter and calibration dyes to be used as a measure independent from the absolute intensity of scattered light, which necessarily includes an unknown noise contribution. The arrangement can thus be thought of as a calibration arrangement for the detection of analyte molecules.

A “dye” is of course well known to the skilled person and is used herein to cover a group having specific optical characteristics and is also known as a “chromophore”. The term “dye” therefore includes a “Raman-active chromophore”. The “dye” should strongly absorb the excitation laser at wavelengths suitable for surface enhancement (the most popular Raman lasers are 514 nm, 532 nm, and 785 nm) . This is in the green-red visible range, so traditional brightly colored dyes are particularly good Raman-active chromophores.

An analyte is any chemical which it is desired to detect or quantify. Examples of suitable analytes include: biological molecules (such as proteins, antibodies, nucleic acids, carbohydrates, proteoglycans, lipids, or hormones), pharmaceuticals or other therapeutic agents and their metabolites, drugs of abuse (for example amphetamines, opiates, benzodiazepines, barbiturates, cannabinoids, cocaine, LSD and their metabolites), explosives (for example nitro-glycerine and nitrotoluenes including TNT, RDX, PETN and HMX), and environmental pollutants (for example herbicides, pesticides).

An analyte sample is any sample which it is desired to test for the presence, or amount, of analyte. There are many situations in which it is desired to test for the presence, absence, or amount, of an analyte. Examples include clinical applications (for example to detect the presence of an antigen or an antibody in a biological sample such as a blood or urine sample), to detect the presence of a drug of abuse (for example in an illicit sample, or a biological sample such as a body fluid or breath sample), to detect explosives, or to detect environmental pollutants (for example in a liquid, air, soil, or plant sample).

Methods of the invention can be used to detect simultaneously several different types of analyte in the analyte sample. This may be achieved by the use of a different selective agent and reporter dye, for each different type of analyte. A single calibration dye could be used with such simultaneous detection, or multiple calibration dyes (for example a different calibration dye for each different type of analyte).

It will be appreciated that in some circumstances the analyte sample may not contain any analyte. For example, it may be desired to show that a particular chemical has been removed by a purification process, or that an infectious agent (or a marker of an infectious agent) is no longer present in a biological sample obtained from a subject following treatment of the subject.

The selective agent is any agent that binds selectively to the analyte in the presence of the other components of the analyte sample, and under the conditions in which the detection method is carried out, so that the presence (or amount) of the analyte in the sample can be detected. The nature of the selective agent will of course depend on the identity of the analyte. In many cases, the selective agent will be an antibody. However, other suitable analyte binding partners may be used. For example, if the analyte is an antibody, the selective agent may be an antigen or antigen derivative that is selectively bound by the antibody. If the analyte is nucleic acid, the selective agent may be a nucleic acid, or a nucleic acid analogue, that hybridizes to the analyte nucleic acid.

The term “antibody” is used herein to include an antibody, or a fragment (for example a Fab fragment, Fd fragment, Fv fragment, dAb fragment, a F(ab′)2 fragment, a single chain Fv molecule, or a CDR region), or derivative of an antibody or fragment that can selectively bind an analyte to allow detection of the analyte.

In some preferred embodiments of the invention, the reporter dye may be part of a reporter. Typically the reporter will comprise the reporter dye, a selective agent binding group, and a metal surface binding group. The reporter is bound to the selective agent (by means of the selective agent binding group) before the analyte sample is introduced to the carrier. Binding of analyte to the selective agent displaces the reporter, which then binds to the metal surface (by means of the metal surface binding group) thereby causing the reporter dye to move to the region near the metal surface.

It is possible that the analyte itself may be intrinsically Raman-active. In such embodiments the reporter dye may be chemically identical to the analyte. Where a reporter is used there is then no need for a separate selective agent binding group.

In general, it is expected that the components of the reporter will be linked together by separate linkers. It will be apparent to the skilled person that there are many possible suitable linkers that could be used. The identity of the linkers will depend on the identity of the components of the reporter. If the selective agent binding group comprises a peptide, it is advantageous if the linker is compatible with conventional peptide linking chemistry. For example, the linker may preferably comprise a single carboxylic acid group for reaction with the N-terminus of the peptide.

In some circumstances, depending on the particular components used, it may be possible to link two or more components of the reporter together without use of a separate linker, for example by reaction between chemical groups of different components of the reporter.

The components of the reporter may be linked together in any order, provided that when the reporter is bound to the surface by means of its metal surface binding group, the reporter dye is within the region near the metal surface.

The metal surface binding group of the reporter should be a group that binds preferentially (typically by adsorption) to the metal surface. In some circumstances, it may be desired that binding of the metal surface binding group to the metal surface is sufficiently strong enough to immobilize the reporter to the metal surface. The chemical nature of the metal surface binding group will depend on the metal surface that is used. Suitable silver binding functional groups include groups having a heterocyclic nitrogen, such as oxazoles, thiazoles, diazoles, triazoles, oxadiazoles, thiadiazoles, oxathiazoles, thiatriazoles, benzotriazoles, tetrazoles, benzimidazoles, indazoles, isoindazoles, benzodiazoles or benzisodiazoles. Other suitable functional groups include amines, amides, thiols, sulphates, thiosulphates, phosphates, thiophosphates, hydroxyls, carbonyls, carboxylates, and thiocarbamates. Amino acids such as cysteine, histidine, lysine, arginine, aspartic acid, glutamic acid, glutamine or arginine also confer silver binding.

It will be appreciated that the attachment of the selective agent to the calibration dye should be stable enough that binding of the analyte to the selective agent does not displace the calibration dye from the selective agent. Typically, the calibration dye will be covalently attached to the selective agent.

The calibration dye may be held in the region near the metal surface by a metal surface binding group that is attached (preferably covalently) to the calibration dye or to the selective agent. Examples of metal surface binding groups are given above. The metal surface binding group attached to the calibration dye or selective agent may be of the same type as the metal surface binding group of the reporter, or of a different type, but it should bind strongly enough to the metal surface to immobilize the calibration dye and the selective agent to the metal surface. The selective agent, calibration dye, and metal surface binding group may be linked together in any order provided that the calibration dye is within the region near the metal surface when the selective agent is immobilised to the metal surface.

In alternative embodiments, the selective agent may be intrinsically Raman-active so that the selective agent performs the function of the calibration dye. In such embodiments there is no need for a separate calibration dye.

### BRIEF DESCRIPTION OF THE DRAWINGS

Embodiments of the invention will now be described, by way of example only, and with reference to the accompanying drawings, in which:

FIG. 1 shows energy levels of Raman scattering;

FIG. 2 is a schematic diagram showing a detector using the principle of Surface-Enhanced Raman Scattering;

FIG. 3 shows the arrangement of calibration and reporter dyes linked to a surface by a selective agent;

FIG. 4 shows a first analyte carrier and detector together forming a detector assembly which may embody the invention;

FIG. 5 shows an alternative analyte carrier which may embody the invention; and

FIG. 6 shows a further alternative analyte carrier which may embody the invention.

### DESCRIPTION OF THE EMBODIMENTS

The embodiments described use the technique of Surface Enhanced Raman Spectroscopy (SERS), but the invention may also be applied to fluorescence emission or to fluorescence quenching. The present embodiments comprise two main components: an analyte carrier which provides an analyte region to support molecules to be analysed; and a detector which provides laser radiation to the analyte region on the carrier and has sensors to detect radiation received from the analyte region. Together the analyte carrier and detector comprise a detector assembly.

The detector itself can comprise various forms of laser source and sensors as described later. The embodiments of analyte carrier, appropriate to the detector can take various forms. The preferred embodiment is a microfluidic chip, but other embodiments include a suitably modified microtiter plate as described later. The analyte carrier is thus a so-called “lab on chip”. Prior to describing the embodiments, the SERS effect will first be briefly described by way of background.

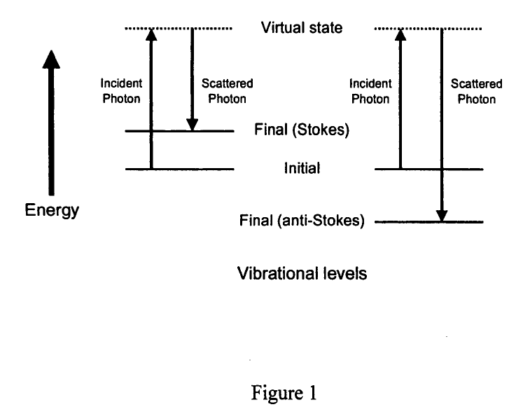

As previously discussed, when light is scattered from a molecule, most of the photons are elastically scattered. The majority of the scattered photons have the same energy (and therefore frequency and wavelength) as the incident photons. However, a small fraction of the light (approximately 1 in 10⁷ photons) is scattered at frequencies different from, and usually lower than, the frequency of the incident photons as shown in FIG. 1. When the scattered photon loses energy to the molecule, it has a longer wavelength than the incident photon (termed Stokes scatter). Conversely, when it gains energy, it has a shorter wavelength (termed anti-Stokes scatter).

The process leading to this inelastic scatter is termed the Raman effect, after Sir C. V. Raman, who discovered it in 1928. It is associated with a change in the vibrational, rotational or electronic energy of the molecule, with the energy transferred from the photon to the molecule usually being dissipated as heat. It is also possible for thermal energy to be transferred to the scattered photon, thus decreasing its wavelength. In classical terms, this interaction can be viewed as a perturbation of the molecule's electric field, which is dependent not just on the specific chemical structure of the molecule, but also on its exact conformation and environment. The energy difference between the incident photon and the Raman scattered photon is equal to the energy of a vibrational state of the scattering molecule, giving rise to scattered photons at quantised energy values. A plot of the intensity of the scattered light versus the energy (wavelength) difference is termed the Raman spectrum [RS]. An explanation of the different energy states is shown in FIG. 1.

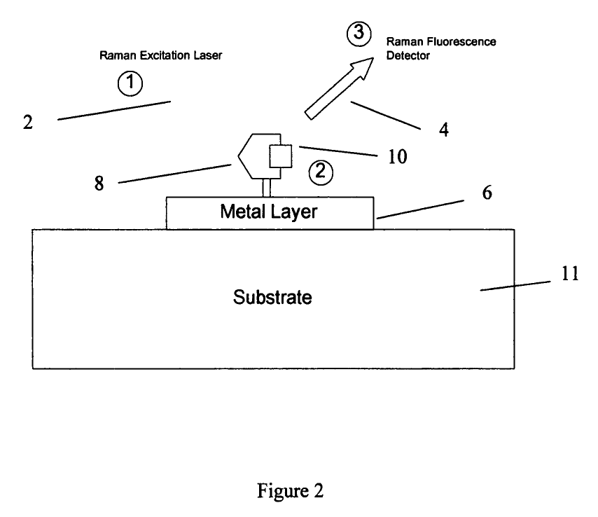

FIG. 2 shows how the Raman scattering from a compound or ion within a few tens of nanometers of a metal surface can be 10³ to 10⁶ times greater than in solution. This Surface-Enhanced Raman scattering (SERS) is strongest on silver, but is readily observable on gold and copper as well. Recent studies have shown that a variety of transition elements may also give useful SERS enhancements. The SERS effect is essentially caused by an energy transfer between the molecules and an electromagnetic field near the surface of a metal caused by electrons in the metal. The precise mechanism that leads to the enhancement of Raman scattering using SERS need not be described here and various models such as coupling of an image of an analyte molecule to electrons in the metal are known to the skilled person. In effect, electrons in the metal layer 6 supply energy to the molecule thereby enhancing the Raman effect.

The presence of a particular molecule is detected using SERS by detecting the wavelength of scattered radiation shown as scattered beam 4. The scattering is not directional and so the sensor (not shown) could be at any reasonable position to capture scattered radiation to measure the wavelength, and hence energy change, of the scattered radiation. The energy change is related to the band gap of molecular states, and hence the presence of particular molecules can be determined. In a known arrangement, a reporter dye is initially bound to a selective agent 8 such as an antibody. Binding of an analyte 10 to the selective agent displaces the reporter dye causing it to move to the metal surface and produce a SERS signal. The reporter dye can be detected by its characteristic Raman shift as shown in FIG. 1.

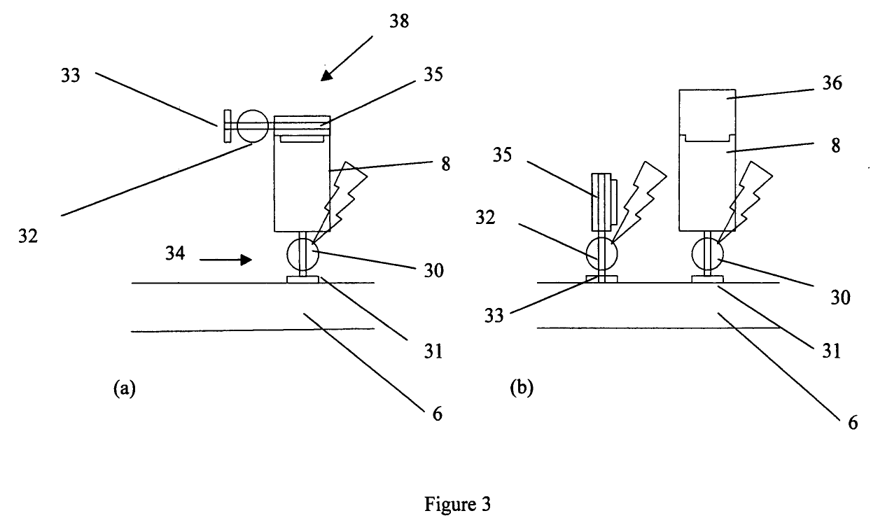

A carrier for use in detecting the presence of an analyte in accordance with an embodiment of the invention is shown in FIGS. 3a and 3b and includes a metal surface 6. A selective agent 8, such as an antibody, is attached to a calibration dye 30 that is held to the surface 6 by a metal surface binding group 31. The calibration dye 30 is within a region 34 such that it is within the effect of the evanescent field from the surface 6 to enhance the SERS effect. A reporter 38 comprises a reporter dye 32 that is linked to a metal surface binding group 33 and a selective agent binding group 35 (for example a peptide that is selectively bound by the antibody). The reporter 38 (and, therefore, the reporter dye 32) is held away from the surface by the antibody 8 and so the reporter dye 32 is outside the region 34. On binding of an analyte 36 to the selective agent 8, the reporter 38 is displaced from the selective agent 8. The metal surface binding group 33 of the reporter 38 then causes the reporter 38 to bind to the surface 6, as shown in FIG. 3b. Binding of the reporter 38 to the surface 6 brings the reporter dye 32 within the region 34 such that it is within the effect of the evanescent field from the surface 6 to enhance the SERS effect.

The signal-to-noise ratio of the detector is enhanced by the use of the two Raman-active groups (i.e. the calibration and reporter dyes): one 32 (the reporter dye) which is normally held away from the surface and released in the presence of the analyte, and the other 30 (the calibration dye) which is permanently located within the evanescent field and thereby serves as an internal calibration signal. Rather than relying on the absolute intensity of the Raman scattered light to provide the quantification metric, this arrangement uses the ratio of the light scattered from each dye. Since the initial ratio of dyes is always a known constant, any observed changes in the ratio provide a quantification metric which is substantially independent from absolute intensity, thereby providing an internally calibrated signal that is much less susceptible to noise due to detector variations, reproducibility of sensor device fabrication, or other noise sources.

When an analyte molecule 36 binds to the selective agent 8, the reporter dye 32 is released from the selective agent, moves into the evanescent field and binds to the surface, as shown on the right. In the first case, only the signal from the calibration dye 30 is produced, since the reporter dye 32 of the reporter 38 is held-away from the surface. When analyte is present, signals are seen from both dyes, and the ratio of the two can be used to quantify the degree to which molecules of the reporter have been displaced, thereby quantifying the amount of analyte present.

The preferred spectral comparison is not a simple ratio of intensities measured at given Raman shifts, although this may serve as a reasonable first approximation. The spectral signals from the dyes are additive, which means that if there is any overlap in spectral peaks between the dyes, then the intensity at any given Raman shift has contributions from both dyes, and the quantitative relationship becomes non-linear with respect to intensity. This is further complicated by the fact that peak intensities themselves are non-linear, particularly for strong peaks (the ‘Beer-Lambert law’). The best way to analyse the spectra is to use non-linear multivariate calibration techniques such as neural networks, genetic programming, partial least-squares analysis or support vector machines. These are well researched in the art and will not be described further.

The preferred dataset to analyse comprises complete Raman spectra—typically collected over the 200-4000 cm-1 range. Individual chemical groups within the dyes will have peaks at specific Raman shifts within these spectra, and these may be used, by the multivariate calibration software, to enable quantification of the reporter relative to the calibrant dyes. Once a quantitative model has been found, it may use only a subset of the full spectra, so it would be possible to design a simplified detector that monitored only these Raman shifts, but that would then be specific to those dyes, and less suitable for a generic technology platform.

In preferred embodiments, the selective agent binding group of the reporter molecules binds to the same site in the selective agent as the analyte. One way to achieve this is to base the selective agent binding group of the reporter on a structural part of the analyte that is selectively bound by the selective agent. For example, if the analyte is a protein, and the selective agent an antibody, then the selective agent binding group of the reporter may comprise a peptide corresponding to the region of the analyte recognised by the antibody. Alternatively, the analyte may be a specific nucleic acid (DNA or RNA, for example). The selective agent binding group of the reporter may then comprise an oligonucleotide whose base sequence corresponds to the part of the analyte that is selectively bound by the selective agent. Likewise, a carbohydrate or proteoglycan analyte may be detected using a reporter comprising a selective agent binding group that comprises sugar groups of the analyte that are selectively bound by the selective agent. For a lipid analyte, the selective agent binding group of the reporter may comprise one or more fatty acid chains derived from the analyte's structure that are selectively bound by the selective agent.

In other embodiments, the reporter may be displaced by an allosteric mechanism. In such embodiments, the selective agent binding group binds to a site on the selective agent that is different to the site at which the analyte binds. Binding of the selective agent binding group to its site causes a change to the site bound by the analyte so that the affinity of the analyte for the selective agent is reduced, and the analyte is then released (i.e. displaced).

According to alternative preferred embodiments of the invention, the analyte may be an enzyme (such as a protease or a nuclease) that can cleave a substrate (such as a nucleic acid or a peptide substrate). In such embodiments, the selective agent comprises a recognition site that can be selectively bound by the enzyme, and a cleavage site that can be cleaved by the enzyme to release (i.e. displace) a reporter dye attached to the selective agent. It will be appreciated that by monitoring the reaction rate and comparing it to the known turnover number for that enzyme/substrate combination it is possible to use such embodiments to determine the amount of analyte enzyme present.

The movement of the reporter molecule to the metal surface could be by a variety of mechanisms, but the simplest is by simple diffusion. Once it is there, the metal binding group holds it in position. Of course, many reporter molecules will simply diffuse away from the surface into the bulk solution. In non-microfluidic detector chambers, this would result in a detector with lower sensitivity, but one that is still viable, since a reproducible proportion of reporter molecules will stick to the surface in a given time. In a microfluidic environment, the detector chamber walls act to constrain the molecules, so they will quickly bounce back and “stick” to the metal (by binding to the metal binding group), thereby increasing sensitivity hugely. Eventually (depending on chamber size and diffusion rates), the majority or even all of the reporters will have stuck to the metal.

There are other techniques for measuring the presence of molecules, one such is known as surface plasmon resonance (SPR). In SPR the electric vector of an excitation laser beam induces a dipole in the surface of a metal layer. The restoring forces from the positive polarisation charge result in an oscillating electromagnetic field at a resonant frequency of this excitation. In the Rayleigh limit, this resonance is determined mainly by the density of free electrons at the surface of the metal layer (the ‘plasmons’) determining the so-called ‘plasma wavelength’, as well as the dielectric constants of the metal and its environment.

Molecules in an analyte absorbed on or in close proximity to the surface of the layer experience an exceptionally large electromagnetic field in which vibrational modes normal to the surface are most strongly enhanced. This is the Surface Plasmon Resonance (SPR) effect, which enables through-space energy transfer between the plasmons in the metal layer and the molecules near the surface. Scattered photons may then be measured using conventional spectroscopic detectors (not shown). An excitation laser beam of plane polarised light is arranged so that it impinges on the metal surface close to the critical angle. This critical angle is determined by the refractive index of the metal. The SPR effect produces an evanescent wave, an electromagnetic field, which extends approximately 400 nm from the metal surface. An energy transfer between this field and the analyte molecules results in a change in the effective refractive index of the layer causing a change in the critical angle and hence a change in the intensity of refracted light, which can be detected using conventional spectroscopic devices.

Another technique for detecting analytes is to combine the SERS and SPR effects in a single detector. In this arrangement, if the excitation wavelength of the SPR beam is varied (e.g. by using a tunable laser) or the composition and thickness of the metal layer is altered, the SPR effect can be selectively optimised to maximise the SERS signal from a particular analyte molecule. The benefits of this are that the strength of the SERS signal can be substantially increased for a given molecule (enabling more sensitive detection), and that the SPR electromagnetic field in a region can be adjusted to selectively enhance the signal from particular components of complex biological mixtures. Since the combined detector uses an artificial SPR field to enhance the fluorescence from the analyte molecules, we have named the technique Surface Plasmon Assisted Raman Spectroscopy (SPARS). Effectively, the second laser is used to pump energy into the excitation produced by the first laser.

Other detection technologies can be used with the technique of having a calibration dye. For example, fluorescence can be used so that a second dye produces fluorescence only when displaced by an analyte molecule. Alternatively, fluorescence quenching may also be used.

The dye groups which generate the signal are chosen according to the detection technology to be employed. If Raman spectroscopy is the chosen detector method, then the enhancement needs to occur in the visible/infrared spectral region. Dye groups which show strong Raman spectroscopic features are therefore preferred, and the sensor materials and morphologies are selected so as to optimise energy transfer in this spectral range. If fluorescence emission is the preferred detection method, then the spectral region of interest is the visible/ultraviolet. Again, the sensor materials and morphologies can be rationally chosen to optimise their effectiveness in this spectral region, and suitably fluorescent dye groups selected from those that are commercially available, or custom synthesised to meet specific application requirements. An alternative to fluorescence emission would be fluorescence quenching. As previously described, the energy transfer between surface adsorbed molecules and the electromagnetic field is a two-way process. The evanescent field can therefore be used as an energy sink to extract energy from excited fluorescent molecules, thereby causing a quenching effect which reduces the fluorescence from molecules close to the metal surface. The sensor would therefore detect an increase in the fluorescence quenching on release of the reporter molecule. In all cases the use of two dyes, one to report a binding event and one to act as a calibration baseline, is used.

Many dyes that can de detected by SERS or SERRS are known and are referred to in the relevant literature (e.g. WO 99/994065). Examples include fluorescein dyes, rhodamine dyes, phthalocyanines, azo dyes, cyanines, xanthines, and succinylfluoresceins. Any compounds with large organic systems and which fluoresce at wavelengths suitable for surface plasmon resonance with the metal (e.g.. >400 nm for silver) may be appropriate.

It will be appreciated that the calibration and reporter dyes must be distinguishable by the particular detection technique that is used.

The specific wavelength shift observed in a Raman spectrum is determined by the frequency of a Raman-active vibrational mode of the molecule. Some chemical groups (eg carboxylates, aromatic rings, methyl groups) provide characteristic vibrational modes by local monmtions in a small number of atoms. Others are due to larger-scale vibrational motions spread throughout the molecule. Raman-active vibrations often occur at the same wavelengths as infrared-active wavelengths. The difference is that a strongly Raman-active vibration induces a change in the polarisability (‘size’) of the group, whereas an infrared-active one induces a change in the dipole (‘charge distribution’).

In some circumstances, the selective agent binding group or the metal surface binding group of the reporter may itself comprise a dye, thereby obviating the need for a separate reporter dye.

Embodiments of analyte carrier will now be described, as well as describing the whole carrier and detector assembly.

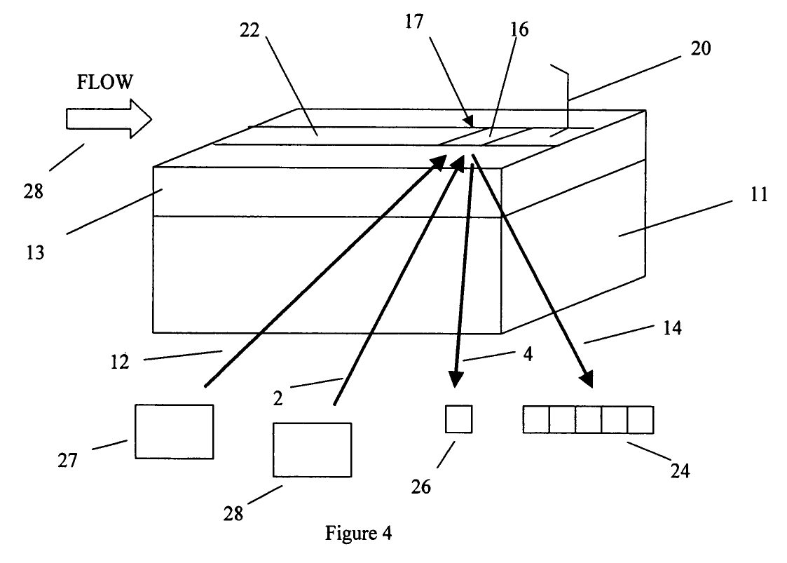

The preferred embodiment of analyte carrier is shown in FIG. 4 and is a form of microfluidic chip. On a substrate 11 of suitable plastic, glass or other appropriate material that is transparent to radiation at the chosen wavelengths, is formed a channel layer 13 having a channel 22. Analyte in solution is introduced to the channel in the direction shown by an arrow. At a region 17 of the channel a conductive or semiconductive layer 16 is formed. This layer is preferably one of copper, aluminium, silver or particularly gold. As previously described, the gold layer maybe colloidal of particle size of the order 80 nm, the particle size within the metal colloid being chosen to provide an appropriate plasmon wavelength as already described.

A primary use of the chip is in the detection of a protein analyte. For this use, a calibration dye attached to an antibody (or other selective agent) that can bind the analyte protein is held to the gold surface 16. The calibration dye is within the region 20 of influence of the evanescent field from the gold surface. A reporter comprises a reporter dye attached to a peptide or similar fragment able to mimic a portion of the analyte protein to which the antibody can bind. The reporter dye is initially held away from the surface by binding of the peptide of the reporter to the antibody. On binding of a protein analyte to the antibody, the reporter is displaced and comes within the region 20 of influence of the evanescent field from the gold surface. The reporter dye is chosen depending upon the protein to be analysed. It is the calibration and reporter dyes that provide the optical effect such as SERS scattering.

The detector into which the analyte carrier chip is inserted comprises a SERS laser 28 providing a beam 2 to the analyte and reporter molecules at the surface region 17 of the gold layer 16. The SERS laser 28 provides radiation at a wavelength chosen to match a bandgap of the reporter molecule and will vary from molecule to molecule. To provide a flexible detector, therefore, the SERS laser is preferably tunable. As SERS scattering 4 is not directional, the sensor 26 for the scattered radiation could be at any position. However, this sensor is preferably not opposite the SERS laser to avoid direct radiation from the laser reaching the sensor.

A laser 27 to provide a plane polarised beam 12 for the SPR effect may also be provided at the critical angle to the surface 16, and a sensor array 24 positioned so as to receive the reflected beam 14. The SPR laser 27 is chosen to have a wavelength to match the surface plasmon resonance, which itself is arranged to couple with the bandgap of the reporter dye molecules. Thus, it is also preferable that the SPR laser 27 is tuneable. The sensor array 24 comprises multiple sensors, each at a slightly differing angle to the reflected beam. Accordingly, as the reporter molecule interacts with the evanescent wave from the surface 16 it changes the SPR refracted radiation which can be detected as a change in angle of the refracted light. Also, as the SPR laser is tuneable, the SPR effect can be measured by sweeping the tuning of the laser and noting the variation in the wavelength at which the refraction occurs for a given detector position when an analyte molecule binds to the anti-body.

Although shown with just one channel, the chip preferably has multiple channels, each of which may contain a different reporter dye and/or antibody (or other selective agent) on the metal layer.

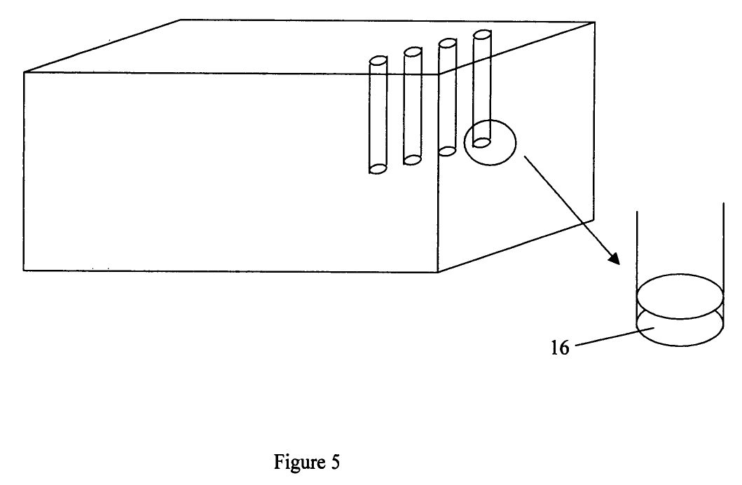

A second embodying analyte carrier is shown in FIG. 5 and comprises a modified microtiter plate. A microtiter plate is known to the skilled person and comprises a series of wells in a substrate, typically of plastic. Samples of an analyte are introduced to the microtiter plate wells for analysis. In accordance with the embodiment of the invention, the bottom of each well, or sides, is modified to include a conductive surface 16. A calibration dye, attached to a selective agent, is held to the surface. A reporter comprising a reporter dye is bound to the selective agent as previously described. The analyte in solution is then introduced into each well and the plate inserted into a detector as previously described in relation to FIG. 4. The conductive surface is preferably gold of typical thickness 50 to 80 nm as previously described. The detector arrangement can illuminate each well in turn, but preferably has an array of detectors to allow simultaneous illumination and detection from each of a plurality of wells in the plate.

For any of the above “lab-on-a-chip” devices, there is the additional possibility of controlling the exact composition of the metal layer 16. Modifying the metal surface 16 with a variety of dopant atoms would provide an additional means of modulating the plasma wavelength, maybe even resulting in an electronically-controllable SPR field.

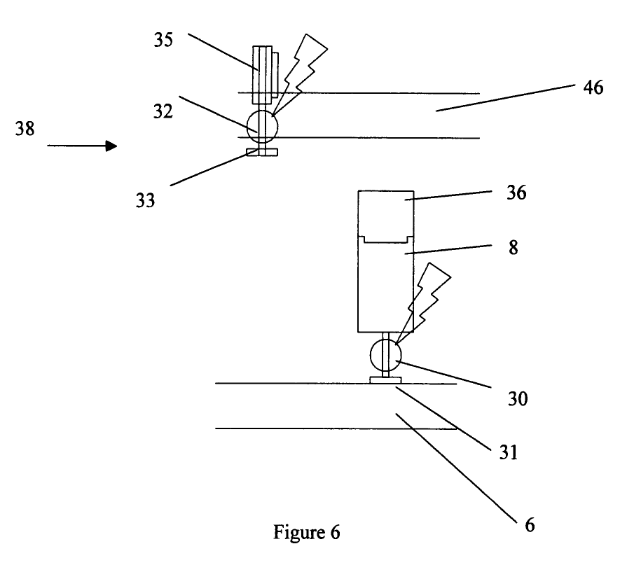

A further alternative embodiment is shown in FIG. 6 in which calibration and reporter dyes are present as before, but with the difference that the analyte carrier comprises two surfaces. A calibration dye 30 attached to a selective agent is held to a first surface 6 as previously described. Also, a reporter dye 32 is part of a reporter 38 which is displaced when an analyte molecule is present. In this alternative embodiment, when the reporter 38 including the reporter dye 32 is displaced from the selective agent 8, it is displaced to a second surface 46. In the lab on chip embodiment described this could be on the opposite side of the channel containing the analyte solution. The detector can therefore be arranged to illuminate the second surface 46 as well as the first surface 6. This could be using different lasers, each of which is chosen so as to best match the Raman spectrum of the selected dyes.

The metal surface at which SERRS detection of the reporter occurs (ie the one where the reporter molecules eventually stick) need not be the one where the antibody/calibration dye is located. However, this would complicate the detector (requiring two metal spots for detection) since the calibration requires a simultaneous quantification of both calibrant and reporter SERRS signal. This is most effectively achieved using a single detection spot and using dyes which can be individually resolved by analysing a single Raman spectrum and so using a single surface region is preferred.

The invention may also be embodied in an arrangement in which the selective agent and dyes are bound to colloidal particles, rather than to a surface as shown. In this arrangement, the calibration dye is held to a particle and the reporter, including the reporter dye, is displaced when an analyte is present. The displacement may be to the same colloidal particle or to a different one. The principle is that the reporter dye is held away from any colloidal metal surface until displaced by an analyte molecule.

The choice of metal surface for SERRS requires a metal able to support plasmons with wavelengths suitable for the coupling of the incident laser and chemical systems. In practice, gold, silver and copper are suitable for visible wavelength lasers, and aluminium for UV lasers. Other metals may also support SERRS, but the ones listed here are the preferred embodiments.

1. A method of detecting the presence or absence of an analyte in a sample, comprising:
providing an analyte carrier having a calibration dye held in a region near a metal surface, and a reporter dye held away from a region near a metal surface, the reporter dye being displaceably attached to a selective agent capable of binding the analyte such when the analyte binds to the selective agent the reporter dye detaches and moves to a region near a metal surface;
introducing a sample to the analyte carrier;
illuminating the analyte carrier; and
detecting for the presence of analyte by measuring a difference in response to the illumination from the reporter dye in comparison to the response to illumination from the calibration dye.

2. A method according to claim 1, wherein the illumination is laser light.

3. A method according to claim 2, wherein the response to illumination is a change in wavelength due to Raman scattering.

4. A method according to claim 3, wherein the response to illumination is SERS.

5. A method according to claim 1, wherein the response to illumination is fluorescence.

6. A method according to claim 1, wherein the response to illumination is fluorescence quenching.

7. A method according to claim 1, wherein the calibration dye is attached to the selective agent.

8. A method according to claim 1, wherein the selective agent performs the function of the calibration dye.

9. A method according to claim 1, wherein the analyte carrier includes a metal layer and the calibration dye is held in a region near the metal layer, and wherein the selective agent is immobilised at the metal layer such that the reporter dye is detachably held away from the metal layer.

10. A method according to claim 9, wherein the reporter dye moves to a region near the metal layer when displaced by an analyte.

11. A method according to claim 9, wherein the analyte carrier includes a second metal layer and wherein the reporter dye moves to a region near the second metal layer when displaced by an analyte.

12. A method according to claim 1, wherein the selective agent is in a colloidal metallic particle suspension such that each selective agent molecule is attached to a metal surface of a colloidal metal particle.

13. A method according to claim 12, wherein the reporter dye of a given selective agent molecule moves to a region near the colloidal metal particle to which the given selective agent is attached.

14. An analyte carrier for use in a detector assembly arrangement, comprising:
a metal surface, a calibration dye held in a region near the metal surface, a selective agent at the metal surface, the selective agent being capable of binding an analyte, and a reporter dye held away from a region near a metal surface, the reporter dye being displaceably attached to the selective agent such that, on binding of analyte in the sample to the selective agent, the reporter dye detaches and moves to a region near a metal surface;
whereby the presence of the analyte can be measured by a difference in response to the illumination from the reporter dye in comparison to the response to illumination from the calibration dye.

15. An analyte carrier according to claim 14, wherein the calibration dye is attached to the selective agent.

16. An analyte carrier according to claim 14, wherein the selective agent performs the function of the calibration dye.

17. An analyte carrier according to claim 14, wherein the analyte carrier includes a metal layer and the calibration dye is held in a region near the metal layer, and wherein the selective agent is immobilised at the metal layer such that the reporter dye is detachably held away from the metal layer.

18. A detector assembly including an analyte carrier according to claim 14, and further comprising a laser light source arranged to illuminate the region near the metal surface and a detector arranged to detect the presence of the analyte by measuring a difference in response to the illumination from the reporter dye in comparison to the response to illumination from the calibration dye.

19. A selective agent attached to a calibration dye and a metal surface binding group for immobilisation of the selective agent to a metal surface of an analyte carrier.

20. A selective agent according to claim 19 that is covalently attached to the calibration dye and metal surface binding group.

21. A selective agent which performs the function of a calibration dye and which is attached, preferably covalently, to a metal surface binding group for immobilisation of the selective agent to a metal surface on an analyte carrier.

22. A selective agent having a calibration dye attached, and a reporter dye displaceably attached such that on binding of an analyte to the selective agent the reporter dye, but not the calibration dye, detaches from the selective agent.

23. A selective agent which performs the function of a calibration dye and which has a reporter dye displaceably attached such that on binding of an analyte to the selective agent the reporter dye detaches from the selective agent.

24. A selective agent according to claim 22 which is attached to a metal surface binding group for immobilisation of the selective agent to a metal surface of an analyte carrier.

25. A selective agent according to claim 22, wherein the reporter dye is part of a reporter which further comprises a selective agent binding group and a metal surface binding group, such that on binding of an analyte to the selective agent the reporter detaches from the selective agent.

26. A method of testing for a presence of an analyte in a sample, comprising: using a selective agent having a calibration dye attached, and a reporter dye displaceably attached, such that upon binding of the analyte to the selective agent, the reporter dye detaches from the selective agent.

27. A method of testing for a presence of an analyte in a sample, comprising: using a selective agent which performs the function of a calibration dye, and which has a reporter dye displaceably attached, such that on binding of the analyte to the selective agent the reported dye detaches from the selective agent.

28. A selective agent according to claim 23 which is attached to a metal surface binding group for immobilisation of the selective agent to a metal surface of an analyte carrier.

29. A selective agent according to claim 23, wherein the reporter dye is part of a reporter which further comprises a selective agent binding group and a metal surface binding group, such that on binding of an analyte to the selective agent the reporter detaches from the selective agent.

30. A selective agent according to claim 24, wherein the reporter dye is part of a reporter which further comprises a selective agent binding group and a metal surface binding group, such that on binding of an analyte to the selective agent the reporter detaches from the selective agent.
